(19) United States
(12) Patent Application Publication
(10) Pub. No.: US 2019/0325043 A1
(43) Pub. Date: Oct. 24, 2019

(54) METHOD, DEVICE AND COMPUTER PROGRAM PRODUCT FOR REPLICATING DATA BLOCK

(71) Applicant: EMC IP Holding Company LLC, Houston, TX (US)

(72) Inventors: Lanjun Liao, Chengdu (CN); Kexin He, Chengdu (CN); Ke Li, Chengdu (CN); Qin Liu, Chengdu (CN); Wei Chen, Chengdu (CN)

(21) Appl. No.: 16/117,575

(22) Filed: Aug. 30, 2018

(30) Foreign Application Priority Data
Apr. 20, 2018 (CN) 201810365408.7

(51) Int. Cl. G06F 17/30; G06F 7/16; H04L 29/08

(52) U.S. Cl. CPC G06F 17/30174; G06F 17/30156; H04L 67/42; G06F 7/16; H04L 67/1095; G06F 17/30097

(57) ABSTRACT

Embodiments of the present disclosure relate to method, device and computer program product for replicating a data block. The method comprises obtaining a first set of identifiers associated with a first client and a second set of identifiers associated with a second client, the first set of identifiers comprising an identifier of a data block having been replicated to a target server from the first client and the second set of identifiers comprising an identifier of a data block having been replicated to the target server from the second client. The method also comprises merging the first set of identifiers and the second set of identifiers into a third set of identifiers to eliminate duplicated identifiers. The method further comprises replicating, based on the third set of identifiers and an identifier of a data block to be replicated, the data block to be replicated to the target server.

### FIELD

Embodiments of the present disclosure relate to the field of data replication, and more specifically, to method, device and computer program product for replicating a data block.

### BACKGROUND

Clients often back up the data into a backup server to ensure data security. When the data is being backed up to the backup server, the same data content for different clients only needs to be backed up one time, which can reduce the amount of storage space required at the backup server.

However, in order to avoid the scenario in which previously stored data cannot be accurately read when a backup server fails, a server provider replicates the data on the backup server to a target server to prevent data loss. When the backup server breaks down, data recovery can be performed from the target server, so as to guarantee data accuracy and integrity. However, it is required that corresponding data management information is created for each client when the data is replicated to the target server from the backup server. When there are a large number of clients connected to the backup server, the data amount of the data management information stored at the backup server end becomes large, which affects the performance of the backup server.

### SUMMARY

Embodiments of the present disclosure provide method, device and computer program product for replicating a data block.

According to an aspect of the present disclosure, there is provided a method of replicating a data block. The method comprises obtaining a first set of identifiers associated with a first client and a second set of identifiers associated with a second client, the first set of identifiers comprising an identifier of a data block having been replicated to a target server from the first client and the second set of identifiers comprising an identifier of a data block having been replicated to the target server from the second client. The method also comprises merging the first set of identifiers and the second set of identifiers into a third set of identifiers to eliminate duplicative identifiers. The method further comprises replicating, based on the third set of identifiers and an identifier of a data block to be replicated, the data block on the target server.

According to an aspect of the present disclosure, there is provided an electronic device for replicating a data block. The electronic device comprises: a processor; and a memory having computer program instructions stored thereon, the processor executing the computer program instructions in the memory to control the electronic device to perform a method. The method comprises obtaining a first set of identifiers associated with a first client and a second set of identifiers associated with a second client, the first set of identifiers comprising an identifier of a data block having been replicated to a target server from the first client and the second set of identifiers comprising an identifier of a data block having been replicated to the target server from the second client. The actions also comprise merging the first set of identifiers and the second set of identifiers into a third set of identifiers to eliminate duplicative identifiers. The actions further comprise replicating, based on the third set of identifiers and an identifier of a data block to be replicated, the data block to be replicated to the target server.

According to an aspect of the present disclosure, there is provided a computer program product. The computer program product is tangibly stored on a non-volatile computer-readable medium and comprises machine-executable instructions which, when executed, causing a machine to perform steps of the method according to one or more aspects of the present disclosure.

### BRIEF DESCRIPTION OF THE DRAWINGS

Through the following more detailed description of the example embodiments of the present disclosure with reference to the accompanying drawings, the above and other objectives, features, and advantages of the present disclosure will become more apparent, wherein the same reference sign usually refers to the same component in the example embodiments of the present disclosure.

FIG. 1 illustrates a schematic diagram of an example environment 100 where device and/or method can be implemented according to embodiments of the present disclosure;

FIG. 2 illustrates a flowchart of a method 200 for merging the sets of identifiers and replicating a data block according to embodiments of the present disclosure;

FIG. 3 illustrates a flowchart of a method 300 for merging the sets of identifiers according to embodiments of the present disclosure;

FIG. 4 illustrates a flowchart of a method 400 for replicating a data block according to embodiments of the present disclosure;

FIG. 5 illustrates a flowchart of a further method 500 for replicating a data block according to embodiments of the present disclosure;

FIG. 6 illustrates a schematic block diagram of an example device 600 suitable for implementing embodiments of the present disclosure.

In each drawing, same or corresponding signs indicate the same or corresponding components.

### DETAILED DESCRIPTION OF EMBODIMENTS

The embodiments of the present disclosure will be described in more details with reference to the drawings. Although the drawings illustrate some embodiments of the present disclosure, it should be appreciated that the present disclosure can be implemented in various manners and should not be limited to the embodiments described herein. On the contrary, the embodiments are provided to understand the present disclosure in a more thorough and complete way. It should be appreciated that drawings and embodiments of the present disclosure are only for exemplary purposes rather than restricting the protection scope of the present disclosure.

In the descriptions of the embodiments of the present disclosure, the term “includes” and its variants are to be considered as open-ended terms that mean “includes, but is not limited to.” The term “based on” is to be understood as “based at least in part on.” The terms “one embodiment” and “this embodiment” are to be read as “at least one embodiment.” The terms “first”, “second” and so on can refer to same or different objects. The following text also can comprise other explicit and implicit definitions.

The principle of the present disclosure will be described with reference to the several example embodiments shown in the drawings. Although the drawings illustrate preferred embodiments of the present disclosure, it should be understood that the embodiments are described herein merely enable those skilled in the art to better understand and further implement the present disclosure and is not intended for limiting the scope of the present disclosure in any manner.

In a backup server, a cache file is established for every client. The cache file is stored with a set of identifiers of data blocks that have been replicated to a target server. However, when the number of clients increases, many cache files are maintained inside the backup server. If each client backs up a large amount of data, the corresponding cache file will become large. Therefore, the cache files for the clients will occupy a large storage space in the backup server, which directly affects the performance of the backup server.

In addition, the data stored in each cache file is for a corresponding client. Therefore, different cache files may store the same data, which leads to store many identical copies of the data being stored in different cache files, which leads to wasted of storage space.

Therefore, the present disclosure provides a technical solution for reducing the size of a cache file. In this technical solution, a plurality of cache files for different clients is merged into one cache file to eliminate duplicated data in the cache files, thereby reducing the storage space occupied by the cache files. After merging a plurality of cache files into one cache file, compression of the cache file, which acts as sparse file, is implemented to save disk space. Further, the data amount to be loaded is reduced during replication because the cache file decreases, thereby saving the cache space.

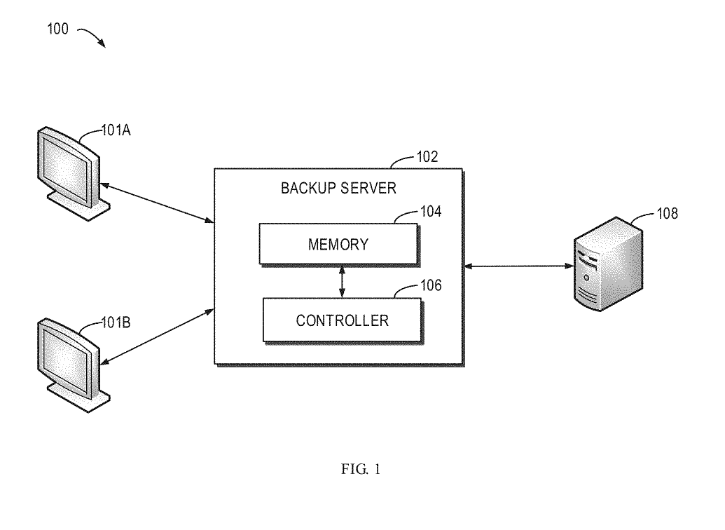

FIG. 1 illustrates a schematic diagram of an example environment 100 where device and/or method can be implemented according to embodiments of the present disclosure. In this environment, there are two clients 101A and 101B, a backup server 102 and a target server 108. The backup server 102 backs up the data from the clients 101A and 101B to avoid loss of data stored in the clients when the client 101A or 101B fails. However, the target server 108 backs up the data from the backup server 102, to avoid loss of data stored in the backup server 102 when the backup server 102 breaks down.

It should be noted that the number of clients and servers shown in FIG. 1 is only illustrative and is not the limitation to the present disclosure, and any number of clients and servers can be included. In one example, the clients 101A and 101B, the backup server 102 and the target server 108 are based on content addressing.

The client 101A and the client 101B can be performed as any types of computing devices, including but not limited to, mobile phone (e.g., smartphone), laptop computer, Portable Digital Assistant (PDA), electronic book (e-book) reader, portable game console, portable media player, game machine, Set-Top-Box (STB), smart television (TV), personal computer, laptop computer, on-board computer (such as navigation unit) and the like.

The client 101A and the client 101B each back up a data block to the backup server 102. In one example, the data blocks transmitted to the backup server 102 by the client 101A and the client 101B are part of a data file stored on client 101A and 101B, respectively. The data file may include, but is not limited to, articles of law, standard and normative electronic documents, digitized medical information, emails and attachments, check images, satellite images and audio/video information etc. In one example, the client 101A and the client 101B split the data file backed up to the backup server 102 into data blocks prior to transmission to the backup server.

To ensure data security and avoid loss caused by failure of the backup server 102, the backup server 102 will replicate the data block to the target server 108. In one example, the backup server 102 only replicates the newly added data to the target server 108. Alternatively or additionally, the backup server 102 replicates, based on a set time point or time period, the data to the target server 108.

A cache file will be established for each client in the backup server 102, where the cache file is stored with a set of identifiers. The set of identifiers includes identifiers of data blocks that have already been replicated to the target server 108. At the backup server 102, when a process for the client replicates the data block from the client to the target server 108, the process will compare identifiers of the data blocks from the client with identifiers in the set of identifiers, and determine, based on the comparison, whether the data blocks will be replicated to the target server 108.

Taking the client 101A as an example, the cache file for the client 101A is stored in the backup server 102. The cache files have a first set of identifiers stored therein, the first set of identifiers including identifiers of the data blocks that are associated with the client 101A and that have been replicated to the target server 108 from the backup server 102. In one example, identifiers are stored sequentially according to the size of the identifier in the set of identifiers. Alternatively or additionally, the identifiers in the first set of identifiers are sequentially stored according to hash calculation of the identifiers. In one example, the first set of identifiers includes identifiers of data blocks that have been replicated to the target server 108 from the client 101A.

When the process for the client 101A replicates a data block from the client 101A to the backup server 102, an identifier of the data block is determined and then the identifier is compared with the first set of identifiers for the client 101A. In one example, if the identifier exists in the first set of identifiers, the data block is not replicated. If the identifier does not exist in the first set of identifiers, the identifier will be transmitted to the target server 108 to determine whether a data block corresponding to the identifier is stored in the target server 108. If a data block corresponding to the identifier is stored in the target server 108, the identifier is stored in the cache file for the client 101A. If a data block corresponding to the identifier is not stored in the target server 108, the data block is replicated to the target server 108 and the identifier is stored in the cache file for the client 101A.

Alternatively, if the identifier does not exist in the first set of identifiers, the data block is directly transmitted to the target server 108 and the identifier is stored in the first set of identifiers.

In one example, the identifier of the data block is acquired by performing hash processing on the data block and the identifier of the data block corresponds to the storage address of the data block. Determining whether there is the data block in the target server 108 is implemented by determining whether there is data block in the address mapped by the identifier.

The sets of identifier in a plurality of cache files for different clients are merged within the backup server 102. The backup server 102 then replicates the data blocks based on the merged set of identifiers.

The target server 108 stores data blocks transmitted from the backup server 102 to implement data backup. When the backup server 102 fails, the target server 108 can provide the data to be recovered for the backup server 102. In one example, the target server 108 also can directly transmit to the client the data to be recovered.

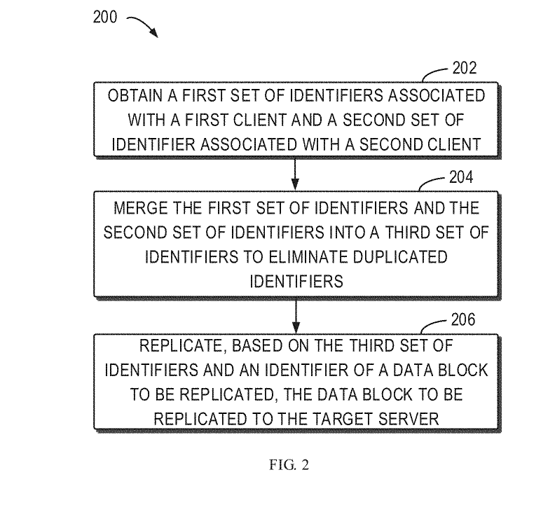

The example environment 100 for replicating the data blocks is described above and a method 200 for merging sets of identifier and replicating the data blocks will described with reference to FIG. 2 in the following. There may be a plurality of clients in the example environment 100. Accordingly, there are also multiple sets of identifiers for the clients on the backup server 102. The two sets of identifiers for the two clients 101A and 101B are described below and the description is only exemplary and does not restrict the present disclosure.

At block 202, a set of identifies (hereinafter referred to as “first set of identifiers”) associated with the client 101A (also known as first client) and a set of identifiers (hereinafter referred to as “second set of identifiers”) associated with the client 101B (also known as second client) are acquired. In one example, the first set of identifiers includes identifiers of data blocks having been replicated to the target server 108 from the first client and the second set of identifiers includes identifiers of data blocks having been replicated to the target server 108 from the second client. In a further example, the first identifier set includes identifiers of data blocks stored on the target server 108 for the first client. The second identifier set includes identifiers of data blocks stored on the target server 108 for the second client.

A procedure of obtaining the first set of identifiers is explained by taking the first client as an example. In one example, when a replication process for the first client is running on the backup server 102, the process acquires an identifier of the data block that is received from the first client and is to be replicated to the target server 108.

In one example, an identifier of the data block is received from the client and stored on the backup server 102. Therefore, the identifier of the data block can be directly obtained at the backup server 102. The identifier is obtained by performing the hash calculation on the block data by the client and uniquely identifies the data block. In one example, the hash processing is performed on the data block replicated to the target server 108 from the first client to obtain a hash value of the data block. After obtaining the hash value, the hash value is determined as the identifier of the data block. In a further example, the identifier is determined by a preconfigured mapping relationship between hash value and identifier after the hash value is obtained. In another example, after obtaining the hash value, the hash value is converted to generate the identifier of the data block. The above methods for forming the identifier are only exemplary and do not restrict the technical solution of the present disclosure. Any methods for determining the identifier through a hash value can be employed.

In addition, a first set of identifiers for the first client is also obtained at the backup server 102. In one example, the first set of identifiers is stored in the backup server 102. In another example, the first set of identifiers is acquired from other devices connected to the backup server 102. Then, an identifier of the data block to be replicated to the target server 108 is compared with the first set of identifiers, and if the identifier of the data block to be replicated matches the first set of identifiers, it means there is the data block in the target server 108. Thus, there is no need to replicate the data block to the target server 108.

If the identifier of the data block to be replicated does not match any of the first set of identifiers, the identifier of the data block to be replicated is transmitted to the target server 108 to determine whether the data block is stored in the target server 108. In one example, the identifier of the data block corresponds to the storage address of the data block. Alternatively or additionally, the identifier of the data block is a storage address of the data block on the target server 108. If the data block exists in the storage address, it means that the target server 108 has stored the data block. Accordingly, only the identifier of the data block is added into the first set of identifiers. If the data block does not exist in the storage address, the identifier of the data block is added into the first set of identifiers and the data block is transmitted to the target server 108 to store the data block at a storage address corresponding to the identifier of the data block.

In one example, the identifier of the data block is mapped, based on the hash calculation, to a predetermined position of the first identifier set, such that the first identifier set is sequentially stored according to the size of the identifier.

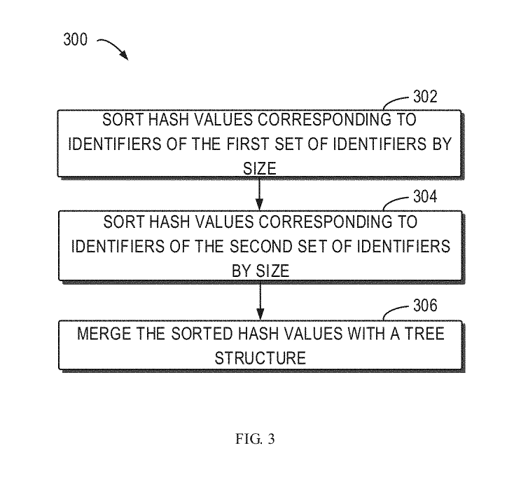

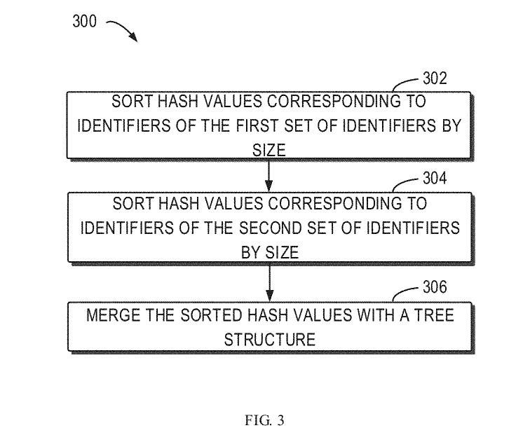

At block 204, the first set of identifiers and the second set of identifiers are merged into a third set of identifiers to eliminate duplicated identifiers. An example of merging the identifiers will be described in details below with reference to FIG. 3. FIG. 3 illustrates a flowchart of a method 300 for merging the sets of identifiers according to embodiments of present disclosure, wherein an example of a procedure for merging the first identifier and the second identifier is depicted.

Before merging the first set of identifiers and the second set of identifiers, it is determined that identifiers in the first set of identifiers and the second set of identifiers are sequentially stored according to the size of the identifier.

At block 302, hash values corresponding to identifiers of the first set of identifiers are sorted by size. In one example, identifiers of the first set of identifiers are stored based on the size of the identifier. Alternatively or additionally, the storage position of the identifier of the set of identifiers is determined based on the hash calculation of the identifier.

At block 304, hash values corresponding to identifiers of the second set of identifiers are sorted by size. In one example, identifiers of the second set of identifiers are stored based on the size of the identifier. Alternatively or additionally, the storage position of the identifier of the set of identifiers is determined based on the hash calculation of the identifier.

Because both the first set of identifiers and the second set of identifiers are the set of identifiers stored in sequence, the sorted sets of identifiers are merged using a tree structure at block 306. The tree structure can have various forms or types, for example, it can be a loser tree, a winner tree and/or trees of any other suitable forms or types.

The two sets of identifiers are merged into one set of identifiers by the above method. The identifiers in the identifier set are configured to be sequentially stored, so as to implement a rapid merging procedure via the tree structure, there by improves merging efficiency.

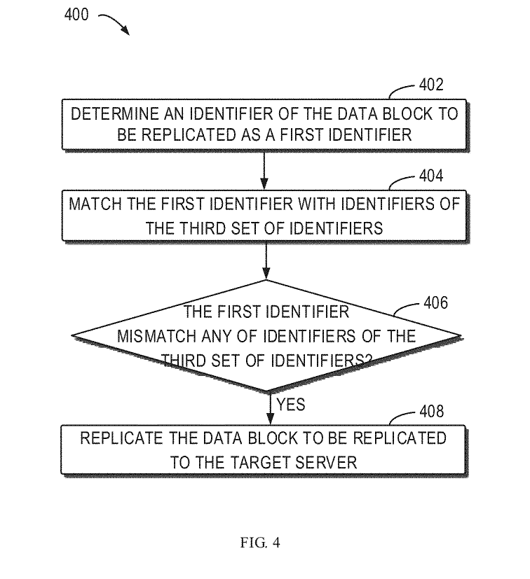

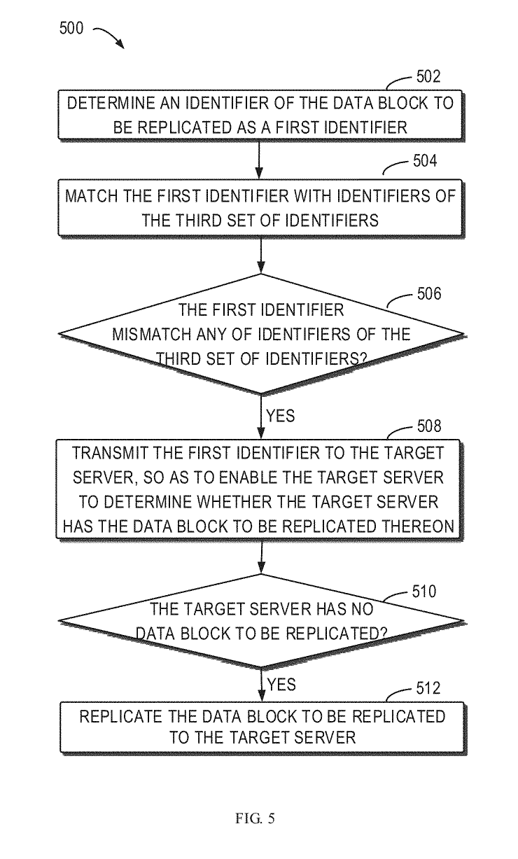

Continuing to refer to FIG. 2, at block 206, the data block to be replicated is replicated, based on a third set of identifiers and the identifier of the data block to be replicated, to the target server 108. After merging the first set of identifiers and the second set of identifiers, the identifier of the data block is matched with the third set of identifiers to determine whether the data block will be transmitted to the target server 108 when the backup server 102 replicates the data to the target server 108. A procedure of data replication based on the third identifier and the identifier of the data block to be replicated will be described in details below with reference to FIGS. 4 and 5.

FIG. 4 illustrates a flowchart of a method 400 for replicating a data block according to embodiments of the present disclosure, wherein an example of a rapid replication of data blocks using the third set of identifiers is depicted in details.

When the third set of identifiers is formed through merging, the following explanation is made by taking the replication of a data block from the first client as an example. The contents below are intended for explaining the replication procedure only, rather than restricting the present disclosure.

When the process for the first client replicates the data block from the first client to the target server 108, the identifier of the data block to be replicated is determined as the first identifier at block 402.

The first identifier matches the identifiers of the third set of identifiers at block 404. If the first identifier matches the identifiers of the third set of identifiers, it means that the data block has been replicated to the target server 108. Thus, there is no need to replicate the data block to the target server 108.

It is required to determine whether the first identifier does not match any identifier of the third set of identifiers at block 406. If yes, the data block to be replicated is replicated to the target server 108 at block 408 and the first identifier is added into the third set of identifiers.

The replication operation of the data block to be replicated can be determined based on a general set of identifiers through the above operations. The use of a merged set of identifiers can avoid the procedure of transmitting the identifier to the replication server for verification when the identifier does not exist in the set of identifiers for one client and exists in the set of identifiers for other clients, thereby reducing data amount of the identifiers transmitted to the replication server, saving the bandwidth and increasing data replication efficiency.

As an alternative implementation of the above method 400, a further method 500 for rapid replication of a data block using the third set of identifiers will be described below with reference to FIG. 5.

In FIG. 5, the contents described in blocks 502-506 will not be described here as they are similar to the contents described in blocks 402-406.

When it is determined that that first identifier does not any identifier of the third set of identifiers, the first identifier is transmitted to the target server 108 at block 508, such that the target server 108 determines whether there is a data block to be replicated in the target server 108.

It is determined whether there is a data block to be replicated on the target server 108 at block 510. If there is no the data block to be replicated on the target server 108, the data block to be replicated is replicated to the target server 108 and the identifier of the data block is added into the third set of identifiers at block 512. If there is a data block corresponding to the first identifier on the target server 108, the backup server 102 will add the first identifier to the third set of identifiers.

Apart from saving bandwidth by reducing the identifiers transmitted to the replication server, the above operation also determines whether a corresponding data block should be transmitted via the first identifier, thereby reducing the amount of data blocks directly transmitted to the replication server.

After merging the sets of identifier for different clients into the third set of identifiers, the replication procedure for each client uses the third set of identifier. In order to ensure data accuracy and security, the third set of identifiers is inaccessible for other process during the executing of the process for writing the identifier into the third set of identifiers.

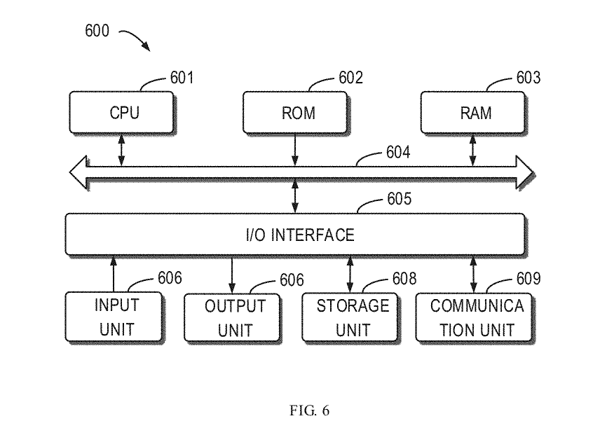

FIG. 6 illustrates a schematic block diagram of an example device 600 for implementing embodiments of the present disclosure. For example, any one of 101A-101B, 102, 106 and 108 shown in FIG. 1 can be performed by the device 600. As shown, the device 600 includes a central process unit (CPU) 601, which can execute various suitable actions and processing based on the computer program instructions stored in the read-only memory (ROM) 602 or computer program instructions loaded in the random-access memory (RAM) 603 from a storage unit 608. The RAM 603 can also store all kinds of programs and data required by the operations of the device 600. CPU 601, ROM 602 and RAM 603 are connected to each other via a bus 604. The input/output (I/O) interface 605 is also connected to the bus 604.

A plurality of components in the device 600 is connected to the I/O interface 605, including: an input unit 606, such as keyboard, mouse and the like; an output unit 607, e.g., various kinds of display and loudspeakers etc.; a storage unit 608, such as disk, optical disk etc.; and a communication unit 609, such as network card, modem, wireless transceiver and the like. The communication unit 609 allows the device 600 to exchange information/data with other devices via the computer network, such as Internet, and/or various telecommunication networks.

The above described various procedures and processing, such as methods 200, 300, 400 and 500, can be executed by the processing unit 601. For example, in some embodiments, 200, 300, 400 or 500 can be implemented as computer software programs tangibly included in the machine-readable medium, such as storage unit 608. In some embodiments, the computer program can be partially or fully loaded and/or mounted to the device 600 via ROM 602 and/or communication unit 609. When the computer program is loaded to RAM 603 and executed by the CPU 601, one or more actions of the above described method 200, 300, 400 or 500 can be performed.

The present disclosure can be method, apparatus, system and/or computer program product. The computer program product can include a computer-readable storage medium having computer-readable program instructions stored thereon for executing various aspects of the present disclosure.

The computer-readable storage medium can be a tangible apparatus that maintains and stores instructions utilized by the instruction executing apparatuses. The computer-readable storage medium can be, but not limited to, such as electrical storage device, magnetic storage device, optical storage device, electromagnetic storage device, semiconductor storage device or any appropriate combinations of the above. More concrete examples of the computer-readable storage medium (non-exhaustive list) include: portable computer disk, hard disk, random-access memory (RAM), read-only memory (ROM), erasable programmable read-only memory (EPROM or flash), static random-access memory (SRAM), portable compact disk read-only memory (CD-ROM), digital versatile disk (DVD), memory stick, floppy disk, mechanical coding devices, punched card stored with instructions thereon, or a projection in a slot, and any appropriate combinations of the above. The computer-readable storage medium utilized here is not interpreted as transient signals per se, such as radio waves or freely propagated electromagnetic waves, electromagnetic waves propagated via waveguide or other transmission media (such as optical pulses via fiber-optic cables), or electric signals propagated via electric wires.

The described computer-readable program instruction herein can be downloaded from the computer-readable storage medium to each computing/processing device, or to an external computer or external storage via network, such as Internet, local area network, wide area network and/or wireless network. The network can include copper-transmitted cable, optical fiber transmission, wireless transmission, router, firewall, switch, network gate computer and/or edge server. The network adapter card or network interface in each computing/processing device receives computer-readable program instructions from the network and forwards the computer-readable program instructions for storing into the computer-readable storage medium of each computing/processing device.

The computer program instructions for executing operations of the present disclosure can be assembly instructions, instructions of instruction set architecture (ISA), machine instructions, machine-related instructions, microcodes, firmware instructions, state setting data, or source codes or target codes written in any combinations of one or more programming languages, wherein the programming languages consist of object-oriented programming languages, such as Smalltalk, C++ and the like, and traditional procedural programming languages, e.g., C language or similar programming languages. The computer-readable program instructions can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, including local area network (LAN) and wide area network (WAN), or to the external computer (e.g., connected via Internet using the Internet service provider). In some embodiments, state information of the computer-readable program instructions is used to customize an electronic circuit, e.g., programmable logic circuit, field programmable gate array (FPGA) or programmable logic array (PLA). The electronic circuit can execute computer-readable program instructions to implement various aspects of the present disclosure.

Each aspect of the present disclosure is disclosed here with reference to the flow chart and/or block diagram of method, apparatus (system) and computer program product according to embodiments of the present disclosure. It should be understood that each block of the flow chart and/or block diagram and combinations of each block in the flow chart and/or block diagram can be implemented by the computer-readable program instructions.

The computer-readable program instructions can be provided to the processing unit of general-purpose computer, dedicated computer or other programmable data processing apparatuses to manufacture a machine, such that the instructions that, when executed by the processing unit of the computer or other programmable data processing apparatuses, generate an apparatus for implementing functions/actions stipulated in one or more blocks in the flow chart and/or block diagram. The computer-readable program instructions can also be stored in the computer-readable storage medium and cause the computer, programmable data processing apparatus and/or other devices to work in a particular manner, such that the computer-readable medium stored with instructions contains an article of manufacture, including instructions for implementing various aspects of the functions/actions stipulated in one or more blocks of the flow chart and/or block diagram.

The computer-readable program instructions can also be loaded into computer, other programmable data processing apparatuses or other devices, so as to execute a series of operation steps on the computer, other programmable data processing apparatuses or other devices to generate a computer-implemented procedure. Therefore, the instructions executed on the computer, other programmable data processing apparatuses or other devices implement functions/actions stipulated in one or more blocks of the flow chart and/or block diagram.

The flow chart and block diagram in the drawings illustrate system architecture, functions and operations that may be implemented by device, method and computer program product according to multiple implementations of the present disclosure. In this regard, each block in the flow chart or block diagram can represent a module, a part of program segment or code, wherein the module and the part of program segment or code include one or more executable instructions for performing stipulated logic functions. In some alternative implementations, it should be noted that the functions indicated in the block can also take place in an order different from the one indicated in the drawings. For example, two successive blocks can be in fact executed in parallel or sometimes in a reverse order dependent on the involved functions. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Various embodiments of the present disclosure have been described above and the above description is only exemplary rather than exhaustive and is not limited to the embodiments disclosed herein. Many modifications and alterations, without deviating from the scope and spirit of the explained various embodiments, are obvious for those skilled in the art. The selection of terms in the text aims to best explain principles and actual applications of each embodiment and technical improvements made to the technology in the market by each embodiment, or enable other ordinary skilled in the art to understand embodiments of the present disclosure.

1. A method of replicating data blocks, comprising:
obtaining a first set of identifiers associated with a first client and a second set of identifiers associated with a second client, the first set of identifiers comprising an identifier of a data block having been replicated to a target server from the first client and the second set of identifiers comprising an identifier of a second data block having been replicated to the target server from the second client;
merging the first set of identifiers and the second set of identifiers into a third set of identifiers to eliminate duplicative identifiers; and
replicating, based on the third set of identifiers and an identifier of a third data block, the third data block to the target server.

2. The method of claim 1, wherein obtaining the first set of identifiers associated with the first client comprises:
performing a hash processing on the data block replicated to the target server from the first client to obtain a hash value of the data block; and
determining the identifier of the data block based on the hash value.

3. The method of claim 1, wherein merging the first set of identifiers and the second set of identifiers into the third set of identifier comprises:
sorting hash values corresponding to identifiers of the first set of identifier by size;
sorting hash values corresponding to identifiers of the second set of identifiers by size; and
merging the sorted hash values using a tree structure.

4. The method of claim 3, wherein the tree structure comprises at least one of a loser tree and a winner tree.

5. The method of claim 1, wherein replicating the third data block to the target server comprises:
determining an identifier of the third data block;
determining that the identifier of the third block does not match any identifiers of the third set of identifiers; and
in response to the determination, replicating the third data block to the target server.

6. The method of claim 1, wherein replicating the third data block to the target server comprises:
determining an identifier of the third data block;
determining that the identifier of third data block does not match any identifiers of the third set of identifiers; and
in response to determination, transmitting the identifier of the third data block to the target server, wherein the target server makes a second determination, using the identifier of the third data block, that the third data block is not stored on the target server; and
in response to the second determination, replicating the third data block to the target server.

7. The method of claim 5, further comprising:
in response to the determination, writing the identifier of the third data block into the third set of identifiers.

8. The method of claim 7, wherein during execution of a process of writing the identifier of the third data block into the third set of identifiers, the third set of identifiers is inaccessible by other processes.

9. An electronic device for replicating data blocks, comprising:
a processor; and
a memory having computer program instructions stored thereon, the processor executing the computer program instructions in the memory to control the electronic device to perform a method, the method comprising:
obtaining a first set of identifiers associated with a first client and a second set of identifiers associated with a second client, the first set of identifiers comprising an identifier of a data block having been replicated to a target server from the first client and the second set of identifiers comprising an identifier of a second data block having been replicated to the target server from the second client;
merging the first set of identifiers and the second set of identifiers into a third set of identifiers to eliminate duplicative identifiers; and
replicating, based on the third set of identifiers and an identifier of a third data block, the third data block to the target server.

10. The electronic device of claim 9, wherein obtaining the first set of identifiers associated with the first client comprises:
performing a hash processing on the data block replicated to the target server from the first client to obtain a hash value of the data block; and
determining the identifier of the data block based on the hash value.

11. The electronic device of claim 9, wherein merging the first set of identifiers and the second set of identifiers into the third set of identifiers comprises:
sorting hash values corresponding to identifiers of the first set of identifiers by size;
sorting hash values corresponding to identifiers of the second set of identifiers by size; and
merging the sorted hash values using a tree structure.

12. The electronic device of claim 11, wherein the tree structure comprises at least one of a loser tree and a winner tree.

13. The electronic device of claim 9, wherein replicating the data block to be replicated to the target server comprises:
determining an identifier of the third data block;
determining that the identifier of the third block does not match any identifiers of the third set of identifiers; and
in response to the determination, replicating the third data block to the target server.

14. The electronic device of claim 9, wherein replicating the third data block to the target server comprises:
determining an identifier of the third data block;
determining that the identifier of the third block does not match any identifiers of the third identifier set; and
in response to the determination, transmitting the identifier of third block to the target server, wherein the target server makes a second determination, using the identifier of third data block, that the third data block is not stored on the target server; and
in response to the second determination, replicating the third data block to the target server.

15. The electronic device of claim 13, the actions further comprise:
in response determination, writing the identifier of the third data block into the third set of identifiers.

16. The electronic device of claim 14, wherein during execution of a process of writing the identifier of the third data block into the third set of identifiers, the third set of identifiers is inaccessible by other processes.

17. A computer program product being tangibly stored on a non-volatile computer-readable medium and comprising machine-executable instructions which, when executed, causing a machine to perform a method, the method comprising:
obtaining a first set of identifiers associated with a first client and a second set of identifiers associated with a second client, the first set of identifiers comprising an identifier of a data block having been replicated to a target server from the first client and the second set of identifiers comprising an identifier of a second data block having been replicated to the target server from the second client;
merging the first set of identifiers and the second set of identifiers into a third set of identifiers to eliminate duplicated duplicative identifiers; and
replicating, based on the third set of identifiers and an identifier of a third data block to be replicated, the third data block to be replicated to the target server.

18. The computer program product of claim 17, wherein merging the first set of identifiers and the second set of identifiers into the third set of identifier comprises:
sorting hash values corresponding to identifiers of the first set of identifier by size;
sorting hash values corresponding to identifiers of the second set of identifiers by size; and
merging the sorted hash values using a tree structure.

19. The computer program product of claim 17, wherein replicating the third data block to the target server comprises:
determining an identifier of the third data block;
determining that the identifier of the third block does not match any identifiers of the third set of identifiers; and
in response to the determination, replicating the third data block to the target server.

20. The computer program product of claim 17, wherein replicating the third data block to the target server comprises:
determining an identifier of the third data block;
determining that the identifier of third data block does not match any identifiers of the third set of identifiers; and
in response to determination, transmitting the identifier of the third data block to the target server, wherein the target server makes a second determination, using the identifier of the third data block, that the third data block is not stored on the target server; and
in response to the second determination, replicating the third data block to the target server.
